(19) United States
(12) Patent Application Publication
(10) Pub. No.: US 2024/0407000 A1
(43) Pub. Date: Dec. 5, 2024

(54) METHOD FOR USING UNLICENSED CHANNEL, APPARATUS, DEVICE, AND STORAGE MEDIUM

(71) Applicant: Beijing Xiaomi Mobile Software Co., Ltd., Beijing (CN)

(72) Inventor: Ting FU, Beijing (CN)

(21) Appl. No.: 18/694,907

(22) PCT Filed: Sep. 29, 2021
(86) PCT No.: PCT/CN2021/121657

§ 371 Date: Mar. 22, 2024

(51) Int. Cl. H04W 74/0816; H04B 7/06; H04W 16/28

(52) U.S. Cl. CPC H04W 74/0816; H04B 7/06968; H04W 16/28

(57) ABSTRACT

A method for using an unlicensed channel includes: performing a listen before talk (LBT) detection on at least one sensing beam, where each sensing beam corresponds to a channel occupy time (COT); and after an idle unlicensed channel is detected on any sensing beam, using the unlicensed channel according to the COT corresponding to the sensing beam.

### BACKGROUND

A radio spectrum resource is a limited and non-renewable natural resource, so different countries have special governing bodies for the radio spectrum and have introduced special policies and regulations to implement unified planning and management for the radio spectrum. At present, spectrum management of most of countries adopts a fixed spectrum allocation strategy, that is, the spectrum resource is managed and allocated to a fixed licensed user by the government department, in this way, it can be ensured that excessive mutual interference between users is avoided, and the spectrum resource is better utilized. The current spectrum resource may be divided into two categories, namely, a licensed spectrum and an unlicensed spectrum.

### SUMMARY

In a first aspect, an example of the disclosure provides a method for using an unlicensed channel, performed by a network device or user equipment and including:
performing a listen before talk (LBT) detection on at least one sensing beam; where each sensing beam corresponds to a channel occupy time; and
using, after an idle unlicensed channel is detected on any sensing beam, the unlicensed channel according to the channel occupy time corresponding to the sensing beam.

In a second aspect, the disclosure provides a communication apparatus, including a processor and a memory; the memory being configured to store a computer program; and the processor being configured to execute the computer program so as to implement the first aspect or any possible design of the first aspect.

In a third aspect, the disclosure provides a non-transitory computer-readable storage medium, storing instructions (or called computer programs or programs) which cause, when called and executed on a computer, the computer to execute the above first aspect or any possible design of the first aspect.

### BRIEF DESCRIPTION OF DRAWINGS

Accompanying drawings described here are used for providing further understanding for the examples of the disclosure and constitute a part of the present application, and examples of the embodiments of the disclosure and their descriptions are used for explaining the examples of the disclosure instead of constituting an inappropriate limitation on the examples of the disclosure. In the accompanying drawings:
the accompanying drawings here, which are incorporated in and constitute a part of the specification, illustrate examples consistent with the examples of the disclosure and, together with the specification, serve to explain principles of the examples of the disclosure.

FIG. 1 is flowchart of a method for using an unlicensed channel shown according to an example;

FIG. 2 is a flowchart of a method for using an unlicensed channel shown according to an example;

FIG. 3 is a structural diagram of a communication apparatus shown according to an example;

FIG. 4 is a structural diagram of another communication apparatus shown according to an example;

FIG. 5 is a structural diagram of a communication apparatus shown according to an example;

FIG. 6 is a structural diagram of another communication apparatus shown according to an example.

### DETAILED DESCRIPTION

The examples of the disclosure are further described with reference to the accompanying drawings and specific implementations.

The examples will be described in detail here, and their instances are represented in the accompanying drawings. Unless otherwise indicated, when the following description refers to the accompanying drawings, the same number in the different accompanying drawings represents the same or similar elements. Implementations described in the following examples do not represent all implementations consistent with the examples of the disclosure. Rather, they are merely examples of an apparatus and method consistent with some aspects of the disclosure as detailed in the appended claims.

The disclosure relates to the technical field of wireless communications, in particular to a method for using an unlicensed channel, apparatus, device, and storage medium.

The licensed spectrum is strictly limited and protected, and merely the licensed user and a device that meets the requirement are permitted to access. Resources of an unlicensed frequency band are rich, in order to ensure fair coexistence between different radio access technologies (RATs) using this frequency band, a listen before talk (LBT) technology based on clear channel assessment (CCA) is introduced, and introducing the LBT into a new radio based unlicensed access (NR-U) is an important way for ensuring fair coexistence.

In the LBT technology, after a sending end performs CCA, if it is judged that a channel is idle, the channel can be occupied for sending data, otherwise, the channel cannot be occupied. The maximum channel occupy time (MCOT) is regulated by a protocol, or configured by a base station or indicated by a base station.

In NR R15/16 stage, the sending end adopts an omnidirectional LBT, the omnidirectional LBT refers to that before sending data, an omnidirectional antenna is used for performing CCA so as to assess a channel interference level; and beam directions are not distinguished in the omnidirectional LBT. In a high frequency band, use of a finer beam is involved, beam-based LBT is researched in NR 52.6-71 GHz, which is also called directional LBT, specifically: before the sending end sends data, a directional antenna is used for performing the CCA so as to conduct interference assessment on a channel in a certain specific direction. A radiation direction of the directional antenna is a part of all directions, namely, specific directions in a narrow range.

How to determine the channel occupy time in a case that the directional LBT is under use is a technical problem to be solved.

In view of this, the disclosure provides a method for using an unlicensed channel, an apparatus, a device, and a storage medium.

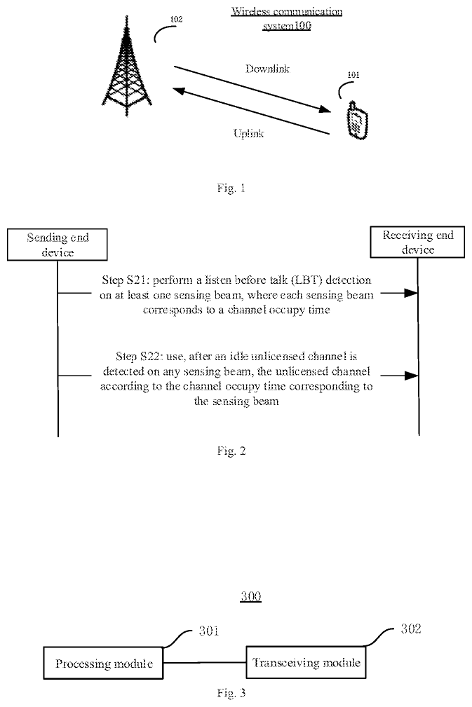

As shown in FIG. 1, a method for using an unlicensed channel provided by an example of the disclosure may be applied to a wireless communication system 100. The wireless communication system may include user equipment 101 and a base station device 102. The user equipment 101 is configured to support carrier aggregation and may be connected to a plurality of carrier units of the base station device 102, and the carrier units include one main carrier unit and one or more auxiliary carrier units.

Application scenes of the wireless communication system 100 include but are not limited to a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, a future evolution public land mobile network (PLMN) system or the like.

The user equipment (UE) 101 shown above may be a terminal, an access terminal, a terminal unit, a terminal station, a mobile station (MS), a remote station, a remote terminal, a mobile terminal, a wireless communication device, a terminal agent, a terminal device or the like. The user equipment 101 may have a wireless transceiving function and can communicate (such as wireless communication) with one or more network devices 102 of one or more communication systems and receive a network service provided by the network device 102. The network device 102 here includes but is not limited to a network device 102 illustrated.

The user equipment 101 may be a cell phone, a cordless telephone, a session initiation protocol (SIP) telephone, a wireless local loop (WLL) station, a personal digital assistant (PDA) device, a handheld device with a wireless communication function, a computing device or another processing device connected to a radio modem, a vehicle-mounted device, a wearable device, a terminal device in the future 5G network, a terminal device in the future evolution PLMN network or the like.

The base station device 102 may specifically include a base station (BS) or include the base station, a wireless resource management device for controlling the base station and the like. The base station device 102 may further include a relay station (relay device), an access point, a base station in the future 5G network, a base station in the future evolution PLMN network, an NR base station or the like. The base station device 102 may be a wearable device or a vehicle-mounted device. The base station device 102 may also be a communication chip with a communication module.

For example, the base station device 102 includes but is not limited to: a next generation base station (gnodeB (gNB)) in 5G, evolved node B (eNB) in the LTE system, a radio network controller (RNC), node B (NB) in a WCDMA system, a wireless controller under the CRAN system, a base station controller (BSC), a base transceiver station (BTS) in a GSM system or a CDMA system, a home base station (for example, home evolved nodeB or home node B (HNB)), a baseband unit (BBU), a transmitting and receiving point (TRP), a transmitting point (TP), a mobile switching center or the like.

In an R15/16 protocol, the channel occupy time (COT) is defined for one sending end, that is, one sending end corresponds to merely one COT at the same moment. In a high-frequency band, the sending end may simultaneously use a plurality of different beams for sending data, and in this case, how is a COT of the sending end to be determined. A beam for performing LBT is called a sensing beam, and a beam for performing data transmission is called a transmission beam.

An example of the disclosure provides a method for using an unlicensed channel. The method is performed by a sending end device. The sending end device is a base station device 102 or user equipment 101.

Referring to FIG. 2, which is a flowchart of a method for using an unlicensed channel shown according to an example. As shown in FIG. 2, the method includes:
step S21: the sending end device performs a listen before talk (LBT) detection on at least one sensing beam; where each sensing beam corresponds to a channel occupy time; and
step S22: the sending end device, after detecting an idle unlicensed channel on any sensing beam, uses the unlicensed channel according to the channel occupy time corresponding to the sensing beam.

In the example of the disclosure, for directional LBT, each sensing beam corresponds to an unlicensed channel occupy time, i.e., for one sending end device, each sensing beam has an own independent COT, such that when using at least one sensing beam to execute the directional LBT, the sending end device determines an occupancy time for a corresponding unlicensed channel according to the channel occupy time of each sensing beam, and a use duration of each unlicensed channel is controlled reasonably on the basis of the properties of the directional LBT of being capable of improving spatial selectivity and improving the channel detection efficiency.

An example of the disclosure provides a method for using an unlicensed channel. The method is performed by a base station device 102. The method for using the unlicensed channel includes:
the base station device 102 performs a listen before talk (LBT) detection on at least one sensing beam; where each sensing beam corresponds to a channel occupy time; and
the base station device 102, after detecting an idle unlicensed channel on any sensing beam, uses the unlicensed channel according to the channel occupy time corresponding to the sensing beam.

An example of the disclosure provides a method for using an unlicensed channel. The method is performed by user equipment 101. The method for using the unlicensed channel includes:
the user equipment 101 performs a listen before talk (LBT) detection on at least one sensing beam; where each sensing beam corresponds to a channel occupy time; and
the user equipment 101, after detecting an idle unlicensed channel on any sensing beam, uses the unlicensed channel according to the channel occupy time corresponding to the sensing beam.

An example of the disclosure provides a method for using an unlicensed channel. The method is performed by a sending end device. The sending end device is a base station device 102 or user equipment 101. The method includes:
step S21: the sending end device performs a listen before talk (LBT) detection on at least one sensing beam; where each sensing beam corresponds to a channel occupy time; and
step S22: the sending end device, after detecting an idle unlicensed channel on any sensing beam, uses the unlicensed channel according to the channel occupy time corresponding to the sensing beam, and uses the sensing beam as a transmission beam to transmit data on the unlicensed channel.

In a possible implementation, the sending end device detects one unlicensed channel when executing the listen before talk (LBT) detection on one sensing beam.

In a possible implementation, the sending end device detects two independent unlicensed channels when executing the listen before talk (LBT) detection on two sensing beams at the same time, where each sensing beam corresponds to an unlicensed channel.

An example of the disclosure provides a method for using an unlicensed channel. The method is performed by a sending end device. The sending end device is a base station device 102 or user equipment 101. The method includes:
step S21: the sending end device performs a listen before talk (LBT) detection on at least one sensing beam; where each sensing beam corresponds to a channel occupy time; and
step S22: the sending end device, after detecting an idle unlicensed channel on any sensing beam, uses the unlicensed channel according to the channel occupy time corresponding to the sensing beam, and uses at least two transmission beams to transmit data on the unlicensed channel; where the at least two transmission beams are associated with the sensing beam.

In a possible implementation, the at least two transmission beams being associated with the sensing beam includes: the at least two transmission beams being located within coverage of the sensing beam.

In a possible implementation, the at least two transmission beams being associated with the sensing beam includes: the at least two transmission beams and the sensing beam are associated with the same reference signal. For example, the same reference signal is a quasi co-location (QCL).

In a possible implementation, as high-level signaling configures a TCI state for a physical layer channel (for example, a PDSCH), and the TCI state includes QCL information. The same reference signal associated with the at least two transmission beams and the sensing beam refers to transmission configuration information (TCI).

In a possible implementation, the at least two transmission beams being associated with the sensing beam includes: a beam direction of each transmission beam in the at least two transmission beams and a beam direction of the sensing beam meeting a first set relationship; The first set relationship may be that a 3 dB beam width of transmission beam is within a 3 dB beam width of the sensing beam, or may also be any set relationship in the prior art.

In a possible implementation, the at least two transmission beams being associated with the sensing beam includes: a quasi co-location of each transmission beam in the at least two transmission beams and a quasi co-location of the sensing beam meeting a second set relationship. The second set relationship may be that a spatial relationship of the transmission beams and the sensing beam is associated with the same reference signal, or may also be any set relationship in the prior art.

An example of the disclosure provides a method for using an unlicensed channel. The method is performed by a sending end device. The sending end device is a base station device 102 or user equipment 101. The method includes:
step S21: the sending end device performs a listen before talk (LBT) detection on at least one sensing beam; where each sensing beam corresponds to a channel occupy time; and
step S22: the sending end device, after detecting an idle unlicensed channel on any sensing beam, uses the unlicensed channel according to the channel occupy time corresponding to the sensing beam, and a plurality of transmission beams for transmitting data share the channel occupy time corresponding to the sensing beam during switching of the transmission beams in a process of transmitting the data.

In a possible implementation, sharing the channel occupy time corresponding to the sensing beam by the plurality of transmission beams for transmitting the data during switching of the transmission beams in the process of transmitting the data includes: consuming the channel occupy time corresponding to the sensing beam by data transmission duration on each transmission beam for transmitting the data.

In an example, a second beam is associated with a first beam, and a COT corresponding to the first beam is 5 ms. The sending end device, after detecting the idle unlicensed channel on the first beam, starts using the unlicensed channel at a moment t1, and uses the first beam to transceive data till a moment t1+2 ms, after the moment t1+2 ms, it is switched to the second beam to transceive data, when a time for transceiving the data by using the second beam reaches 3 ms, namely, reaching a moment t1+5 ms, it is determined that the COT of the unlicensed channel is up, and the sending end device stops using the unlicensed channel and stops sending or receiving data on the unlicensed channel.

In an example, the second beam, a third beam and the first beam are associated, and the COT corresponding to the first beam is 5 ms. The sending end device, after detecting the idle unlicensed channel on the first beam, starts using the unlicensed channel at the moment t1 and uses the second beam to transceive data till a moment t1+1 ms, after the moment t1+1 ms, it is switched to the third beam to transceive data, when a time for transceiving the data by using the third beam reaches 2 ms, namely, reaching a moment t1+3 ms, it is switched to the first beam to transceive data, when a time for transceiving the data by using the first beam reaches 2 ms, namely, reaching the moment t1+5 ms, it is determined that the COT of the unlicensed channel is up, and the sending end device stops using the unlicensed channel and stops sending or receiving data on the unlicensed channel.

Based on the concept the same as the above method example, an example of the disclosure further provides a communication apparatus. The communication apparatus may have functions of a network device 102 in the above method example and may be configured to execute steps executed by the network device 102 provided by the above method example. The functions may be implemented through hardware or software or by executing the corresponding software through hardware. The hardware or software includes one or more modules corresponding to the above functions.

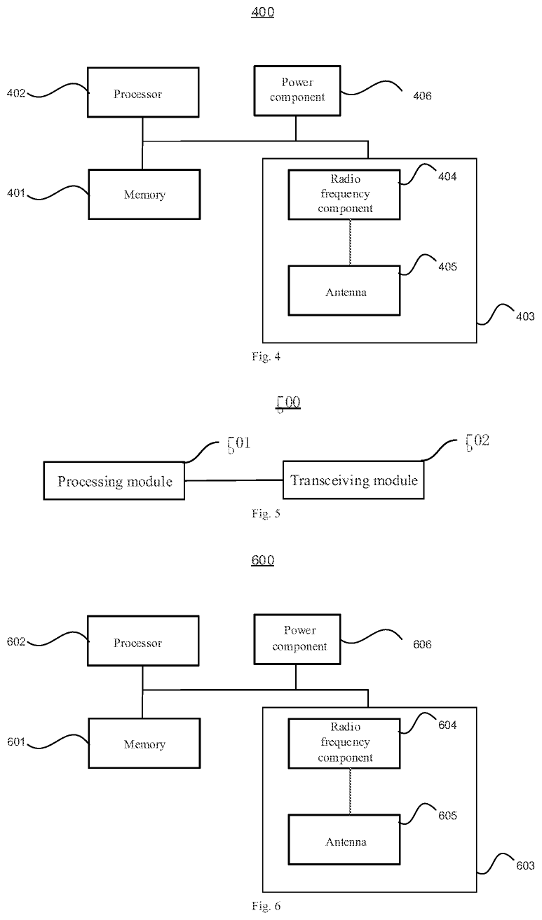

In a possible implementation, the communication apparatus 300 shown in FIG. 3 may serve as the network device 102 involved in the above method example and execute the steps executed by the network device 102 in the above method example. As shown in FIG. 3, the communication apparatus 300 may include a processing module 301 and a transceiving module 302. The processing module 301 is coupled with the transceiving module 302. The processing module 301 may be configured for the communication apparatus 300 to execute a processing operation, including but not limited to: generating information and messages sent by the transceiving module 302, and/or demodulating and decoding a signal received by the transceiving module 302, and the like. The transceiving module 302 may be configured to support the communication apparatus 300 for communication. The transceiving module 302 may have a wireless communication function, for example, can perform wireless communication with another communication apparatus through a wireless radio.

When the steps implemented by the network device 102 are executed, the transceiving module 302 is configured to perform a listen before talk (LBT) detection on at least one sensing beam; where each sensing beam corresponds to a channel occupy time; the processing module 301 is configured to determine that an idle unlicensed channel is detected on any sensing beam; and the transceiving module 302 is further configured to use the unlicensed channel according to the channel occupy time corresponding to the sensing beam after the processing module determines that the idle unlicensed channel is detected on any sensing beam.

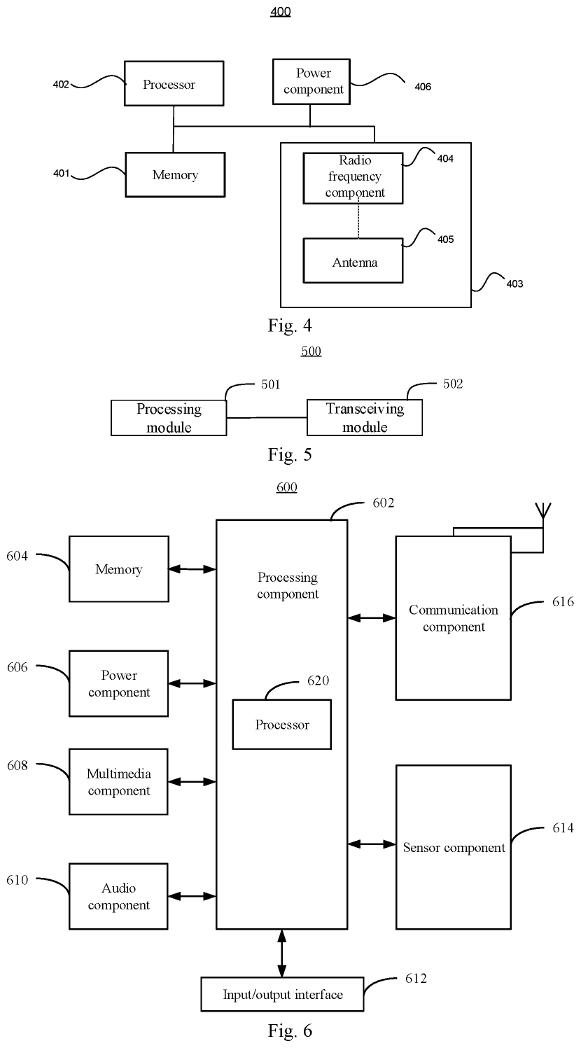

When the communication apparatus is the network device 102, its structure may further be shown in FIG. 4. The structure of the communication apparatus is described by taking a base station as an example. As shown in FIG. 4, the apparatus 400 includes a memory 401, a processor 402, a transceiving component 403 and a power component 406. The memory 401 is coupled with the processor 402 and may be configured to store a program and data needed for implementing the functions by the communication apparatus 400. The processor 402 is configured to support the communication apparatus 400 for executing the corresponding functions in the above method, and the functions may be implemented by calling the program stored in the memory 401. The transceiving component 403 may be a wireless transceiver and may be configured to support the communication apparatus 400 for receiving signaling and/or data and sending signaling and/or data through a wireless radio. The transceiving component 403 may also be called a transceiving unit or a communication unit and may include a radio frequency component 404 and one or more antennas 405. The radio frequency component 404 may be a remote radio unit (RRU), and may be specifically configured for transmission of a radio frequency signal and conversion between the radio frequency signal and a baseband signal. The one or more antennas 405 may be specifically configured for radiation and receiving of the radio frequency signal.

When the communication apparatus 400 needs to send data, the processor 402 performs baseband processing on the to-be-sent data, and then outputs a baseband signal to the radio unit, the radio unit performs radio frequency processing on the baseband signal and then sends a radio frequency signal in a form of electromagnetic wave through the antenna. When data is sent to the communication apparatus 400, the radio unit receives a radio frequency signal through the antenna, converts the radio frequency signal to a baseband signal and then outputs the baseband signal to the processor 402, and the processor 402 converts the baseband signal to data and processes the data.

Based on the concept the same as the above method example, an example of the disclosure further provides a communication apparatus. The communication apparatus may have functions of user equipment 101 in the above method example and may be configured to execute steps executed by the user equipment 101 provided by the above method example. The functions may be implemented through hardware or software or by executing the corresponding software through hardware. The hardware or software includes one or more modules corresponding to the above functions.

In a possible implementation, the communication apparatus 500 shown in FIG. 5 may serve as the user equipment 101 involved in the above method example and execute the steps executed by the user equipment 101 in the above method example. As shown in FIG. 5, the communication apparatus 500 may include a transceiving module 502. The transceiving module 502 may be configured to support the communication apparatus 500 for communication. The transceiving module 502 may have a wireless communication function, for example, can perform wireless communication with another communication apparatus through a wireless radio.

When the steps implemented by the user equipment 101 are executed, the transceiving module 502 is configured to perform a listen before talk (LBT) detection on at least one sensing beam; where each sensing beam corresponds to a channel occupy time; a processing module 501 is configured to determine that an idle unlicensed channel is detected on any sensing beam; and the transceiving module 502 is further configured to use the unlicensed channel according to the channel occupy time corresponding to the sensing beam after the processing module determines that the idle unlicensed channel is detected on any sensing beam.

When the communication apparatus is the user equipment 101, its structure may further be shown in FIG. 6. The apparatus 600 may be a mobile phone, a computer, a digital broadcast terminal, a messaging device, a game console, a tablet device, a medical device, a fitness facility, a personal digital assistant and the like.

Those skilled in the art will easily figure out other implementation solutions of the examples of the disclosure after considering the specification and practicing the disclosure disclosed here. The disclosure intends to cover any variation, use or adaptive change of the examples of the disclosure, and these variations, uses or adaptive changes conform to a general principle of the examples of the disclosure and include common general knowledge or conventional technical means in the technical field not disclosed by the disclosure. The specification and the examples are merely regarded as examples, and the true scope and spirit of the examples of the disclosure are indicated by the following claims.

It is to be understood that the examples of the disclosure are not limited to an accurate structure described above and shown in the accompanying drawings, and various modifications and changes can be made without departing from its scope. The scope of the examples of the disclosure is limited merely by the appended claims.

Referring to FIG. 6, the apparatus 600 may include one or more components as follows: a processing component 602, a memory 604, a power component 606, a multimedia component 608, an audio component 610, an input/output (I/O) interface 612, a sensor component 614 and a communication component 616.

The processing component 602 generally controls a whole operation of the apparatus 600, such as operations related to display, a phone call, data communication, a camera operation and a recording operation. The processing component 602 may include one or more processors 620 for executing instructions so as to complete all or part of steps of the above method. Besides, the processing component 602 may include one or more modules to facilitate interaction between the processing component 602 and the other components. For example, the processing component 602 may include a multimedia module so as to facilitate interaction between the multimedia component 608 and the processing component 602.

The memory 604 is configured to store various types of data so as to support operations on the apparatus 600. Examples of these data include instructions of any application program or method for an operation on the apparatus 600, contact person data, telephone directory data, messages, pictures, videos and the like. The memory 604 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or a compact disc.

The power component 606 provides power for various components of the apparatus 600. The power component 606 may include a power management system, one or more power sources, and other components related to power generation, management and distribution for the apparatus 600.

The multimedia component 608 includes a screen which provides an output interface between the apparatus 600 and a user. In some examples, the screen may include a liquid crystal display (LCD) and a touch panel (TP). If the screen includes the touch panel, the screen may be implemented as a touch screen so as to receive an input signal from the user. The touch panel includes one or more touch sensors so as to sense touching, swiping and gestures on the touch panel. The touch sensor can not only sense a boundary of a touching or swiping action, but also detect duration and pressure related to a touching or swiping operation. In some examples, the multimedia component 608 includes a front camera and/or a back camera. When the apparatus 600 is in an operation mode, such as a photographing mode or a video mode, the front camera and/or the back camera may receive external multimedia data. Each front camera and each back camera may be a fixed optical lens system or have a focal length and an optical zoom capability.

The audio component 610 is configured to output and/or input an audio signal. For example, the audio component 610 includes a microphone (MIC). When the apparatus 600 is in the operation mode, such as a call mode, a recording mode and a voice recognition mode, the microphone is configured to receive an external audio signal. The received audio signal may be further stored in the memory 604 or sent via the communication component 616. In some examples, the audio component 610 further includes a speaker for outputting the audio signal.

The I/O interface 612 provides an interface between the processing component 602 and a peripheral interface module, and the above peripheral interface module may be a keyboard, a click wheel, buttons and the like. These buttons may include but are not limited to: a home button, a volume button, a start button and a lock button.

The sensor component 614 includes one or more sensors, configured to provide state evaluation of various aspects for the apparatus 600. For example, the sensor component 614 may detect a start/shut-down state of the apparatus 600 and relative positioning of the components, for example, the components are a display and a keypad of the apparatus 600. The sensor component 614 may further detect location change of the apparatus 600 or one component of the apparatus 600, whether there is contact between a user and the apparatus 600, azimuth or acceleration/deceleration of the apparatus 600 and temperature change of the apparatus 600. The sensor component 614 may include a proximity sensor, configured to detect existence of a nearby object without any physical contact. The sensor component 614 may further include an optical sensor, such as a CMOS or CCD image sensor, for use in imaging application. In some examples, the sensor component 614 may further include an acceleration sensor, a gyroscope sensor, a magnetic sensor, a pressure sensor or a temperature sensor.

The communication component 616 is configured to facilitate wired or wireless communication between the apparatus 600 and other devices. The apparatus 600 may access a wireless network based on a communication standard, such as WiFi, 4G or 5G, or their combination. In an example, the communication component 616 receives a broadcast signal from an external broadcast management system or broadcasts related information via a broadcast channel. In an example, the communication component 616 further includes a near-field communication (NFC) module so as to facilitate short-range communication. For example, the NFC module may be implemented based on a radio frequency identification (RFID) technology, an infra-red data association (IrDA) technology, an ultra wide band (UWB) technology, a Bluetooth (BT) technology and other technologies.

In an example, the apparatus 600 may be implemented by one or more than one application specific integrated circuit (ASIC), digital signal processor (DSP), digital signal processing device (DSPD), programmable logic device (PLD), field-programmable gate array (FPGA), controller, micro control unit, microprocessor or other electronic elements for executing the above method.

In an example, a non-transitory computer-readable storage medium including instructions is further provided, such as a memory 604 including the instructions. The above instructions may be executed by a processor 620 of an apparatus 600 so as to complete the above method. For example, the non-transitory computer-readable storage medium may be an ROM, a random access memory (RAM), a CD-ROM, a magnetic tape, a floppy disk, an optical data storage device and the like.

Those skilled in the art will easily figure out other implementation solutions of the examples of the disclosure after considering the specification and practicing the disclosure disclosed here. The disclosure intends to cover any variation, use or adaptive change of the examples of the disclosure, and these variations, uses or adaptive changes conform to a general principle of the examples of the disclosure and include common general knowledge or conventional technical means in the technical field not disclosed by the disclosure. The specification and the examples are merely regarded as examples, and the true scope and spirit of the examples of the disclosure are indicated by the following claims.

It is to be understood that the examples of the disclosure are not limited to an accurate structure described above and shown in the accompanying drawings, and various modifications and changes can be made without departing from its scope. The scope of the examples of the disclosure is limited merely by the appended claims.

In view of this, the disclosure provides a method for using an unlicensed channel, an apparatus, a device, and a storage medium.

In a first aspect, an example of the disclosure provides a method for using an unlicensed channel, performed by a network device or user equipment and including:
performing a listen before talk (LBT) detection on at least one sensing beam; where each sensing beam corresponds to a channel occupy time; and
using, after an idle unlicensed channel is detected on any sensing beam, the unlicensed channel according to the channel occupy time corresponding to the sensing beam.

In the present method, for directional LBT, each sensing beam corresponds to an unlicensed channel occupy time, i.e., for one sending end device, each sensing beam has an own independent COT, such that when using at least one sensing beam to execute the directional LBT, the sending end device determines the occupancy time for a corresponding unlicensed channel according to the channel occupy time of each sensing beam, and a use duration of each unlicensed channel is controlled reasonably on the basis of the properties of the directional LBT of being capable of improving spatial selectivity and improving the channel detection efficiency.

In a possible implementation, the method further includes: using, after the idle unlicensed channel is detected on any sensing beam, the sensing beam as a transmission beam to transmit data on the unlicensed channel.

In a possible implementation, the method further includes: using, after the idle unlicensed channel is detected on any sensing beam, at least two transmission beams to transmit data on the unlicensed channel; where the at least two transmission beams are associated with the sensing beam.

In a possible implementation, the at least two transmission beams being associated with the sensing beam includes:
a beam direction of each transmission beam in the at least two transmission beams and a beam direction of the sensing beam meeting a first set relationship.

In a possible implementation, the at least two transmission beams being associated with the sensing beam includes:
a quasi co-location of each transmission beam in the at least two transmission beams and a quasi co-location of the sensing beam meeting a second set relationship.

In a possible implementation, the method further includes: sharing the channel occupy time corresponding to the sensing beam by a plurality of transmission beams for transmitting data during switching of the transmission beams in a process of transmitting the data.

In a possible implementation, sharing the channel occupy time corresponding to the sensing beam by the plurality of transmission beams for transmitting the data during switching of the transmission beams in the process of transmitting the data includes: consuming the channel occupy time corresponding to the sensing beam by data transmission duration on each transmission beam for transmitting the data.

In a second aspect, an example of the disclosure provides a communication apparatus. The communication apparatus may be configured to execute steps executed by a network device in the above first aspect or in any possible design in the first aspect. The network device may implement functions in the above methods in a form of a hardware structure, a software module or combining the hardware structure and the software module.

When the communication apparatus shown in the second aspect is implemented through the software module, the communication apparatus may include a processing module and a transceiving module which are coupled with each other, where the processing module may be configured for the communication apparatus for executing a processing operation, such as generating information/messages needing to be sent, or processing a received signal so as to obtain information/messages, and the transceiving module may be configured to support the communication apparatus for communication.

When the steps in the first aspect are executed, the transceiving module is configured to perform a listen before talk (LBT) detection on at least one sensing beam; where each sensing beam corresponds to a channel occupy time; the processing module is configured to determine that an idle unlicensed channel is detected on any sensing beam; and the transceiving module is further configured to use the unlicensed channel according to the channel occupy time corresponding to the sensing beam after the processing module determines that the idle unlicensed channel is detected on any sensing beam.

In a third aspect, an example of the disclosure provides a communication apparatus. The communication apparatus may be configured to execute steps executed by user equipment in the above first aspect or in any possible design in the first aspect. The user equipment may implement functions in the above methods in a form of a hardware structure, a software module or combining the hardware structure and the software module.

When the communication apparatus shown in the third aspect is implemented through the software module, the communication apparatus may include a processing module and a transceiving module which are coupled with each other, where the processing module may be configured for the communication apparatus for executing a processing operation, such as generating information/messages needing to be sent, or processing a received signal so as to obtain information/messages, and the transceiving module may be configured to support the communication apparatus for communication.

When the steps in the first aspect are executed, the transceiving module is configured to perform a listen before talk (LBT) detection on at least one sensing beam; where each sensing beam corresponds to a channel occupy time; the processing module is configured to determine that an idle unlicensed channel is detected on any sensing beam; and the transceiving module is further configured to use the unlicensed channel according to the channel occupy time corresponding to the sensing beam after the processing module determines that the idle unlicensed channel is detected on any sensing beam.

In a fourth aspect, the disclosure provides a communication apparatus, including a processor and a memory; the memory being configured to store a computer program; and the processor being configured to execute the computer program so as to implement the first aspect or any possible design of the first aspect.

In a fifth aspect, the disclosure provides a computer-readable storage medium, storing instructions (or called computer programs or programs) which cause, when called and executed on a computer, the computer to execute the above first aspect or any possible design of the first aspect.

Beneficial effects of the above first aspect to the fifth aspect and their possible designs may refer to descriptions of beneficial effects of the method in the first aspect and any possible design of the first aspect.

It is to be understood that the above general description and the following detailed description are merely examples and explanatory instead of limiting the disclosure.

### Industrial Applicability

For directional LBT, each sensing beam corresponds to an unlicensed channel occupy time, i.e., for one sending end device, each sensing beam has an own independent COT, such that when using at least one sensing beam to execute the directional LBT, the sending end device determines an occupancy time for a corresponding unlicensed channel according to the channel occupy time of each sensing beam, and a use duration of each unlicensed channel is controlled reasonably on the basis of the properties of the directional LBT of being capable of improving spatial selectivity and improving the channel detection efficiency.

### TECHNICAL FIELD

The disclosure relates to the technical field of wireless communications, in particular to a method for using an unlicensed channel, apparatus, device, and storage medium.

### BACKGROUND

A radio spectrum resource is a limited and non-renewable natural resource, so different countries have special governing bodies for the radio spectrum and have introduced special policies and regulations to implement unified planning and management for the radio spectrum. At present, spectrum management of most of countries adopts a fixed spectrum allocation strategy, that is, the spectrum resource is managed and allocated to a fixed licensed user by the government department, in this way, it can be ensured that excessive mutual interference between users is avoided, and the spectrum resource is better utilized. The current spectrum resource may be divided into two categories, namely, a licensed spectrum and an unlicensed spectrum.

The licensed spectrum is strictly limited and protected, and merely the licensed user and a device that meets the requirement are permitted to access. Resources of an unlicensed frequency band are rich, in order to ensure fair coexistence between different radio access technologies (RATs) using this frequency band, a listen before talk (LBT) technology based on clear channel assessment (CCA) is introduced, and introducing the LBT into a new radio based unlicensed access (NR-U) is an important way for ensuring fair coexistence.

In the LBT technology, after a sending end performs CCA, if it is judged that a channel is idle, the channel can be occupied for sending data, otherwise, the channel cannot be occupied. The maximum channel occupy time (MCOT) is regulated by a protocol, or configured by a base station or indicated by a base station.

In NR R15/16 stage, the sending end adopts an omnidirectional LBT, the omnidirectional LBT refers to that between sending data, an omnidirectional antenna is used for performing CCA so as to assess a channel interference level; and beam directions are not distinguished in the omnidirectional LBT. In a high frequency band, use of a finer beam is involved, beam-based LBT is researched in NR 52.6-71 GHz, which is also called directional LBT, specifically: before the sending end sends data, a directional antenna is used for performing the CCA so as to conduct interference assessment on a channel in a certain specific direction. A radiation direction of the directional antenna is a part of all directions, namely, specific directions in a narrow range.

How to determine the channel occupy time in a case that the directional LBT is under use is a technical problem to be solved.

### SUMMARY

In view of this, the disclosure provides a method for using an unlicensed channel, an apparatus, a device, and a storage medium.

In a first aspect, an example of the disclosure provides a method for using an unlicensed channel, performed by a network device or user equipment and including:
performing a listen before talk (LBT) detection on at least one sensing beam; where each sensing beam corresponds to a channel occupy time; and
using, after an idle unlicensed channel is detected on any sensing beam, the unlicensed channel according to the channel occupy time corresponding to the sensing beam.

In the present method, for directional LBT, each sensing beam corresponds to an unlicensed channel occupy time, i.e., for one sending end device, each sensing beam has an own independent COT, such that when using at least one sensing beam to execute the directional LBT, the sending end device determines the occupancy time for a corresponding unlicensed channel according to the channel occupy time of each sensing beam, and a use duration of each unlicensed channel is controlled reasonably on the basis of the properties of the directional LBT of being capable of improving spatial selectivity and improving the channel detection efficiency.

In a possible implementation, the method further includes: using, after the idle unlicensed channel is detected on any sensing beam, the sensing beam as a transmission beam to transmit data on the unlicensed channel.

In a possible implementation, the method further includes: using, after the idle unlicensed channel is detected on any sensing beam, at least two transmission beams to transmit data on the unlicensed channel; where the at least two transmission beams are associated with the sensing beam.

In a possible implementation, the at least two transmission beams being associated with the sensing beam includes:
a beam direction of each transmission beam in the at least two transmission beams and a beam direction of the sensing beam meeting a first set relationship.

In a possible implementation, the at least two transmission beams being associated with the sensing beam includes:
a quasi co-location of each transmission beam in the at least two transmission beams and a quasi co-location of the beam direction of the sensing beam meeting a second set relationship.

In a possible implementation, the method further includes: sharing the channel occupy time corresponding to the sensing beam by a plurality of transmission beams for transmitting data during switching of the transmission beams in a process of transmitting the data.

In a possible implementation, sharing the channel occupy time corresponding to the sensing beam by the plurality of transmission beams for transmitting the data during switching of the transmission beams in the process of transmitting the data includes: consuming the channel occupy time corresponding to the sensing beam by data transmission duration on each transmission beam for transmitting the data.

In a second aspect, an example of the disclosure provides a communication apparatus. The communication apparatus may be configured to execute steps executed by a network device in the above first aspect or in any possible design in the first aspect. The network device may implement functions in the above methods in a form of a hardware structure, a software module or combining the hardware structure and the software module.

When the communication apparatus shown in the second aspect is implemented through the software module, the communication apparatus may include a processing module and a transceiving module which are coupled with each other, where the processing module may be configured for the communication apparatus for executing a processing operation, such as generating information/messages needing to be sent, or processing a received signal so as to obtain information/messages, and the transceiving module may be configured to support the communication apparatus for communication.

When the steps in the first aspect are executed, the transceiving module is configured to perform a listen before talk (LBT) detection on at least one sensing beam; where each sensing beam corresponds to a channel occupy time; the processing module is configured to determine that an idle unlicensed channel is detected on any sensing beam; and the transceiving module is further configured to use the unlicensed channel according to the channel occupy time corresponding to the sensing beam after the processing module determines that the idle unlicensed channel is detected on any sensing beam.

In a third aspect, an example of the disclosure provides a communication apparatus. The communication apparatus may be configured to execute steps executed by user equipment in the above first aspect or in any possible design in the first aspect. The user equipment may implement functions in the above methods in a form of a hardware structure, a software module or combining the hardware structure and the software module.

When the communication apparatus shown in the third aspect is implemented through the software module, the communication apparatus may include a processing module and a transceiving module which are coupled with each other, where the processing module may be configured for the communication apparatus for executing a processing operation, such as generating information/messages needing to be sent, or processing a received signal so as to obtain information/messages, and the transceiving module may be configured to support the communication apparatus for communication.

When the steps in the first aspect are executed, the transceiving module is configured to perform a listen before talk (LBT) detection on at least one sensing beam; where each sensing beam corresponds to a channel occupy time; the processing module is configured to determine that an idle unlicensed channel is detected on any sensing beam; and the transceiving module is further configured to use the unlicensed channel according to the channel occupy time corresponding to the sensing beam after the processing module determines that the idle unlicensed channel is detected on any sensing beam.

In a fourth aspect, the disclosure provides a communication apparatus, including a processor and a memory; the memory being configured to store a computer program; and the processor being configured to execute the computer program so as to implement the first aspect or any possible design of the first aspect.

In a fifth aspect, the disclosure provides a computer-readable storage medium, storing instructions (or called computer programs or programs) which cause, when called and executed on a computer, the computer to execute the above first aspect or any possible design of the first aspect.

Beneficial effects of the above first aspect to the fifth aspect and their possible designs may refer to descriptions of beneficial effects of the method in the first aspect and any possible design of the first aspect.

It is to be understood that the above general description and the following detailed description are merely examples and explanatory instead of limiting the disclosure.

### BRIEF DESCRIPTION OF DRAWINGS

Accompanying drawings described here are used for providing further understanding for the examples of the disclosure and constitute a part of the present application, and examples of the embodiments of the disclosure and their descriptions are used for explaining the examples of the disclosure instead of constituting an inappropriate limitation on the examples of the disclosure. In the accompanying drawings:
the accompanying drawings here, which are incorporated in and constitute a part of the specification, illustrate examples consistent with the examples of the disclosure and, together with the specification, serve to explain principles of the examples of the disclosure.

FIG. 1 is flowchart of a method for using an unlicensed channel shown according to an example;

FIG. 2 is a flowchart of a method for using an unlicensed channel shown according to an example;

FIG. 3 is a structural diagram of an apparatus for transmitting time-frequency resource configuration information shown according to an example;

FIG. 4 is a structural diagram of another apparatus for transmitting time-frequency resource configuration information shown according to an example;

FIG. 5 is a structural diagram of an apparatus for transmitting time-frequency resource configuration information shown according to an example;

FIG. 6 is a structural diagram of another apparatus for transmitting time-frequency resource configuration information shown according to an example.

### DETAILED DESCRIPTION

The examples of the disclosure are further described with reference to the accompanying drawings and specific implementations.

The examples will be described in detail here, and their instances are represented in the accompanying drawings. Unless otherwise indicated, when the following description refers to the accompanying drawings, the same number in the different accompanying drawings represents the same or similar elements. Implementations described in the following examples do not represent all implementations consistent with the examples of the disclosure. Rather, they are merely examples of an apparatus and method consistent with some aspects of the disclosure as detailed in the appended claims.

As shown in FIG. 1, a method for transmitting time-frequency resource configuration information provided by an example of the disclosure may be applied to a wireless communication system 100. The wireless communication system may include user equipment 101 and a base station device 102. The user equipment 101 is configured to support carrier aggregation and may be connected to a plurality of carrier units of the base station device 102, and the carrier units include one main carrier unit and one or more auxiliary carrier units.

Application scenes of the wireless communication system 100 include but are not limited to a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, a future evolution public land mobile network (PLMN) system or the like.

The user equipment (UE) 101 shown above may be a terminal, an access terminal, a terminal unit, a terminal station, a mobile station (MS), a remote station, a remote terminal, a mobile terminal, a wireless communication device, a terminal agent, a terminal device or the like. The user equipment 101 may have a wireless transceiving function and can communicate (such as wireless communication) with one or more network devices 102 of one or more communication systems and receive a network service provided by the network device 102. The network device 102 here includes but is not limited to a network device 102 illustrated.

The user equipment 101 may be a cell phone, a cordless telephone, a session initiation protocol (SIP) telephone, a wireless local loop (WLL) station, a personal digital assistant (PDA) device, a handheld device with a wireless communication function, a computing device or another processing device connected to a radio modem, a vehicle-mounted device, a wearable device, a terminal device in the future 5G network, a terminal device in the future evolution PLMN network or the like.

The base station device 102 may specifically include a base station (BS) or include the base station, a wireless resource management device for controlling the base station and the like. The base station device 102 may further include a relay station (relay device), an access point, a base station in the future 5G network, a base station in the future evolution PLMN network, an NR base station or the like. The base station device 102 may be a wearable device or a vehicle-mounted device. The base station device 102 may also be a communication chip with a communication module.

For example, the base station device 102 includes but is not limited to: a next generation base station (gnodeB (gNB)) in 5G, evolved node B (eNB) in the LTE system, a radio network controller (RNC), node B (NB) in a WCDMA system, a wireless controller under the CRAN system, a basestation controller (BSC), a base transceiver station (BTS) in a GSM system or a CDMA system, a home base station (for example, home evolved nodeB or home node B (HNB)), a baseband unit (BBU), a transmitting and receiving point (TRP), a transmitting point (TP), a mobile switching center or the like.

In an R15/16 protocol, the channel occupy time (COT) is defined for one sending end, that is, one sending end corresponds to merely one COT at the same moment. In a high-frequency band, the sending end may simultaneously use a plurality of different beams for sending data, and in this case, how is a COT of the sending end to be determined. A beam for performing LBT is called a sensing beam, and a beam for performing data transmission is called a transmission beam.

An example of the disclosure provides a method for using an unlicensed channel. The method is performed by a sending end device. The sending end device is a base station device 102 or user equipment 101.

Referring to FIG. 2, which is a flowchart of a method for using an unlicensed channel shown according to an example. As shown in FIG. 2, the method includes:
step S21: the sending end device performs a listen before talk (LBT) detection on at least one sensing beam; where each sensing beam corresponds to a channel occupy time; and
step S22: the sending end device, after detecting an idle unlicensed channel on any sensing beam, uses the unlicensed channel according to the channel occupy time corresponding to the sensing beam.

In the example of the disclosure, for directional LBT, each sensing beam corresponds to an unlicensed channel occupy time, i.e., for one sending end device, each sensing beam has an own independent COT, such that when using at least one sensing beam to execute the directional LBT, the sending end device determines an occupancy time for a corresponding unlicensed channel according to the channel occupy time of each sensing beam, and a use duration of each unlicensed channel is controlled reasonably on the basis of the properties of the directional LBT of being capable of improving spatial selectivity and improving the channel detection efficiency.

An example of the disclosure provides a method for using an unlicensed channel. The method is performed by a base station device 102. The method for using the unlicensed channel includes:
the base station device 102 performs a listen before talk (LBT) detection on at least one sensing beam; where each sensing beam corresponds to a channel occupy time; and
the base station device 102, after detecting an idle unlicensed channel on any sensing beam, uses the unlicensed channel according to the channel occupy time corresponding to the sensing beam.

An example of the disclosure provides a method for using an unlicensed channel. The method is performed by user equipment 102. The method for using the unlicensed channel includes:
the user equipment 102 performs a listen before talk (LBT) detection on at least one sensing beam; where each sensing beam corresponds to a channel occupy time; and
the user equipment 102, after detecting an idle unlicensed channel on any sensing beam, uses the unlicensed channel according to the channel occupy time corresponding to the sensing beam.

An example of the disclosure provides a method for using an unlicensed channel. The method is performed by a sending end device. The sending end device is a base station device 102 or user equipment 101. The method includes:
step S21: the sending end device performs a listen before talk (LBT) detection on at least one sensing beam; where each sensing beam corresponds to a channel occupy time; and
step S22: the sending end device, after detecting an idle unlicensed channel on any sensing beam, uses the unlicensed channel according to the channel occupy time corresponding to the sensing beam, and uses the sensing beam as a transmission beam to transmit data on the unlicensed channel.

In a possible implementation, the sending end device detects one unlicensed channel when executing the listen before talk (LBT) detection on one sensing beam.

In a possible implementation, the sending end device detects two independent unlicensed channels when executing the listen before talk (LBT) detection on two sensing beams at the same time, where each sensing beam corresponds to an unlicensed channel.

An example of the disclosure provides a method for using an unlicensed channel. The method is performed by a sending end device. The sending end device is a base station device 102 or user equipment 101. The method includes:
step S21: the sending end device performs a listen before talk (LBT) detection on at least one sensing beam; where each sensing beam corresponds to a channel occupy time; and
step S22: the sending end device, after detecting an idle unlicensed channel on any sensing beam, uses the unlicensed channel according to the channel occupy time corresponding to the sensing beam, and uses at least two transmission beams to transmit data on the unlicensed channel; where the at least two transmission beams are associated with the sensing beam.

In a possible implementation, the at least two transmission beams being associated with the sensing beam includes: the at least two transmission beams being located within coverage of the sensing beam.

In a possible implementation, the at least two transmission beams being associated with the sensing beam includes: the at least two transmission beams and the sensing beam are associated with the same reference signal. For example, the same reference signal is a quasi co-location (QCL).

In a possible implementation, as high-level signaling configures a TCI state for a physical layer channel (for example, a PDSCH), and the TCI state includes QCL information. The same reference signal associated with the at least two transmission beams and the sensing beam refers to transmission configuration information (TCI).

In a possible implementation, the at least two transmission beams being associated with the sensing beam includes: a beam direction of each transmission beam in the at least two transmission beams and a beam direction of the sensing beam meeting a first set relationship; and the corresponding first set relationship. The first set relationship may be that a 3 dB beam width of sending beam is within a 3 dB beam width of the sensing beam, or may also be any set relationship in the prior art.

In a possible implementation, the at least two transmission beams being associated with the sensing beam includes: a quasi co-location of each transmission beam in the at least two transmission beams and a quasi co-location of the beam direction of the sensing beam meeting a second set relationship. The second set relationship may be that a spatial relationship of the sending beams and the sensing beam is associated with the same reference signal, or may also be any set relationship in the prior art.

An example of the disclosure provides a method for using an unlicensed channel. The method is performed by a sending end device. The sending end device is a base station device 102 or user equipment 101. The method includes:
step S21: the sending end device performs a listen before talk (LBT) detection on at least one sensing beam; where each sensing beam corresponds to a channel occupy time; and
step S22: the sending end device, after detecting an idle unlicensed channel on any sensing beam, uses the unlicensed channel according to the channel occupy time corresponding to the sensing beam, and a plurality of transmission beams for transmitting data share the channel occupy time corresponding to the sensing beam during switching of the transmission beams in a process of transmitting the data.

In a possible implementation, sharing the channel occupy time corresponding to the sensing beam by the plurality of transmission beams for transmitting the data during switching of the transmission beams in the process of transmitting the data includes: consuming the channel occupy time corresponding to the sensing beam by data transmission duration on each transmission beam for transmitting the data.

In an example, a second beam is associated with a first beam, and a COT corresponding to the first beam is 5 ms. The sending end device, after detecting the idle unlicensed channel on the first beam, starts using the unlicensed channel at a moment t1, and uses the first beam to transceive data till a moment t1+2 ms, after the moment t1+2 ms, it is switched to the second beam to transceive data, when a time for transceiving the data by using the second beam reaches 3 ms, namely, reaching a moment t1+5 ms, it is determined that the COT of the unlicensed channel is up, and the sending end device stops using the unlicensed channel and stops sending or receiving data on the unlicensed channel.

In an example, the second beam, a third beam and the first beam are associated, and the COT corresponding to the first beam is 5 ms. The sending end device, after detecting the idle unlicensed channel on the first beam, starts using the unlicensed channel at the moment t1 and uses the second beam to transceive data till a moment t1+1 ms, after the moment t1+1 ms, it is switched to the third beam to transceive data, when a time for transceiving the data by using the third beam reaches 2 ms, namely, reaching a moment t1+3 ms, it is switched to the first beam to transceive data, when a time for transceiving the data by using the first beam reaches 2 ms, namely, reaching the moment t1+5 ms, it is determined that the COT of the unlicensed channel is up, and the sending end device stops using the unlicensed channel and stops sending or receiving data on the unlicensed channel.

Based on the concept the same as the above method example, an example of the disclosure further provides a communication apparatus. The communication apparatus may have functions of a network device 102 in the above method example and may be configured to execute steps executed by the network device 102 provided by the above method example. The functions may be implemented through hardware or software or by executing the corresponding software through hardware. The hardware or software includes one or more modules corresponding to the above functions.

In a possible implementation, the communication apparatus 300 shown in FIG. 3 may serve as the network device 102 involved in the above method example and execute the steps executed by the network device 102 in the above method example. As shown in FIG. 3, the communication apparatus 300 may include a processing module 301 and a transceiving module 302. The processing module 301 is coupled with the transceiving module 302. The processing module 301 may be configured for the communication apparatus 300 to execute a processing operation, including but not limited to: generating information and messages sent by the transceiving module 301, and/or demodulating and decoding a signal received by the transceiving module 501, and the like. The transceiving module 302 may be configured to support the communication apparatus 300 for communication. The transceiving module 301 may have a wireless communication function, for example, can perform wireless communication with another communication apparatus through a wireless radio.

When the steps implemented by the network device 102 are executed, the transceiving module 302 is configured to perform a listen before talk (LBT) detection on at least one sensing beam; where each sensing beam corresponds to a channel occupy time; the processing module 301 is configured to determine that an idle unlicensed channel is detected on any sensing beam; and the transceiving module 302 is further configured to use the unlicensed channel according to the channel occupy time corresponding to the sensing beam after the processing module determines that the idle unlicensed channel is detected on any sensing beam.

When the communication apparatus is the network device 102, its structure may further be shown in FIG. 4. The structure of the communication apparatus is described by taking a base station as an example. As shown in FIG. 4, the apparatus 400 includes a memory 401, a processor 402, a transceiving component 403 and a power component 406. The memory 401 is coupled with the processor 402 and may be configured to store a program and data needed for implementing the functions by the communication apparatus 400. The processor 402 is configured to support the communication apparatus 400 for executing the corresponding functions in the above method, and the functions may be implemented by calling the program stored in the memory 401. The transceiving component 403 may be a wireless transceiver and may be configured to support the communication apparatus 400 for receiving signaling and/or data and sending signaling and/or data through a wireless radio. The transceiving component 403 may also be called a transceiving unit or a communication unit and may include a radio frequency component 404 and one or more antennas 405. The radio frequency component 404 may be a remote radio unit (RRU), and may be specifically configured for transmission of a radio frequency signal and conversion between the radio frequency signal and a baseband signal. The one or more antennas 405 may be specifically configured for radiation and receiving of the radio frequency signal.

When the communication apparatus 400 needs to send data, the processor 402 performs baseband processing on the to-be-sent data, and then outputs a baseband signal to the radio unit, the radio unit performs radio frequency processing on the baseband signal and then sends a radio frequency signal in a form of electromagnetic wave through the antenna. When data is sent to the communication apparatus 400, the radio unit receives a radio frequency signal through the antenna, converts the radio frequency signal to a baseband signal and then outputs the baseband signal to the processor 402, and the processor 402 converts the baseband signal to data and processes the data.

Based on the concept the same as the above method example, an example of the disclosure further provides a communication apparatus. The communication apparatus may have functions of user equipment 101 in the above method example and may be configured to execute steps executed by the user equipment 101 provided by the above method example. The functions may be implemented through hardware or software or by executing the corresponding software through hardware. The hardware or software includes one or more modules corresponding to the above functions.

In a possible implementation, the communication apparatus 500 shown in FIG. 5 may serve as the user equipment 101 involved in the above method example and execute the steps executed by the user equipment 101 in the above method example. As shown in FIG. 5, the communication apparatus 500 may include a transceiving module 501. The transceiving module 501 may be configured to support the communication apparatus 500 for communication. The transceiving module 501 may have a wireless communication function, for example, can perform wireless communication with another communication apparatus through a wireless radio.

When the steps implemented by the user equipment 101 are executed, the transceiving module 502 is configured to perform a listen before talk (LBT) detection on at least one sensing beam; where each sensing beam corresponds to a channel occupy time; a processing module 501 is configured to determine that an idle unlicensed channel is detected on any sensing beam; and the transceiving module 502 is further configured to use the unlicensed channel according to the channel occupy time corresponding to the sensing beam after the processing module determines that the idle unlicensed channel is detected on any sensing beam.

When the communication apparatus is the user equipment 101, its structure may further be shown in FIG. 6. The apparatus 600 may be a mobile phone, a computer, a digital broadcast terminal, a messaging device, a game console, a tablet device, a medical device, a fitness facility, a personal digital assistant and the like.

Those skilled in the art will easily figure out other implementation solutions of the examples of the disclosure after considering the specification and practicing the disclosure disclosed here. The disclosure intends to cover any variation, use or adaptive change of the examples of the disclosure, and these variations, uses or adaptive changes conform to a general principle of the examples of the disclosure and include common general knowledge or conventional technical means in the technical field not disclosed by the disclosure. The specification and the examples are merely regarded as examples, and the true scope and spirit of the examples of the disclosure are indicated by the following claims.

It is to be understood that the examples of the disclosure are not limited to an accurate structure described above and shown in the accompanying drawings, and various modifications and changes can be made without departing from its scope. The scope of the examples of the disclosure is limited merely by the appended claims.

Referring to FIG. 6, the apparatus 600 may include one or more components as follows: a processing component 602, a memory 604, a power component 606, a multimedia component 608, an audio component 610, an input/output (I/O) interface 612, a sensor component 614 and a communication component 616.

The processing component 602 generally controls a whole operation of the apparatus 600, such as operations related to display, a phone call, data communication, a camera operation and a recording operation. The processing component 602 may include one or more processors 620 for executing instructions so as to complete all or part of steps of the above method. Besides, the processing component 602 may include one or more modules to facilitate interaction between the processing component 602 and the other components. For example, the processing component 602 may include a multimedia module so as to facilitate interaction between the multimedia component 608 and the processing component 602.

The memory 604 is configured to store various types of data so as to support operations on the device 600. Examples of these data include instructions of any application program or method for an operation on the apparatus 600, contact person data, telephone directory data, messages, pictures, videos and the like. The memory 604 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or a compact disc.

The power component 606 provides power for various components of the apparatus 600. The power component 606 may include a power management system, one or more power sources, and other components related to power generation, management and distribution for the apparatus 600.

The multimedia component 608 includes a screen which provides an output interface between the apparatus 600 and a user. In some examples, the screen may include a liquid crystal display (LCD) and a touch panel (TP). If the screen includes the touch panel, the screen may be implemented as a touch screen so as to receive an input signal from the user. The touch panel includes one or more touch sensors so as to sense touching, swiping and gestures on the touch panel. The touch sensor can not only sense a boundary of a touching or swiping action, but also detect duration and pressure related to a touching or swiping operation. In some examples, the multimedia component 608 includes a front camera and/or a back camera. When the apparatus 600 is in an operation mode, such as a photographing mode or a video mode, the front camera and/or the back camera may receive external multimedia data. Each front camera and each back camera may be a fixed optical lens system or have a focal length and an optical zoom capability.

The audio component 610 is configured to output and/or input an audio signal. For example, the audio component 610 includes a microphone (MIC). When the apparatus 600 is in the operation mode, such as a call mode, a recording mode and a voice recognition mode, the microphone is configured to receive an external audio signal. The received audio signal may be further stored in the memory 604 or sent via the communication component 616. In some examples, the audio component 610 further includes a speaker for outputting the audio signal.

The I/O interface 612 provides an interface between the processing component 602 and a peripheral interface module, and the above peripheral interface module may be a keyboard, a click wheel, buttons and the like. These buttons may include but are not limited to: a home button, a volume button, a start button and a lock button.

The sensor component 614 includes one or more sensors, configured to provide state evaluation of various aspects for the apparatus 600. For example, the sensor component 614 may detect a start/shut-down state of the apparatus 600 and relative positioning of the components, for example, the components are a display and a keypad of the apparatus 600. The sensor component 614 may further detect location change of the apparatus 600 or one component of the apparatus 600, whether there is contact between a user and the apparatus 600, azimuth or acceleration/deceleration of the apparatus 600 and temperature change of the apparatus 600. The sensor component 614 may include a proximity sensor, configured to detect existence of a nearby object without any physical contact. The sensor component 614 may further include an optical sensor, such as a CMOS or CCD image sensor, for use in imaging application. In some examples, the sensor component 614 may further include an acceleration sensor, a gyroscope sensor, a magnetic sensor, a pressure sensor or a temperature sensor.

The communication component 616 is configured to facilitate wired or wireless communication between the apparatus 600 and other devices. The apparatus 600 may access a wireless network based on a communication standard, such as WiFi, 4G or 5G, or their combination. In an example, the communication component 616 receives a broadcast signal from an external broadcast management system or broadcasts related information via a broadcast channel. In an example, the communication component 616 further includes a near-field communication (NFC) module so as to facilitate short-range communication. For example, the NFC module may be implemented based on a radio frequency identification (RFID) technology, an infra-red data association (IrDA) technology, an ultra wide band (UWB) technology, a Bluetooth (BT) technology and other technologies.

In an example, the apparatus 600 may be implemented by one or more than one application specific integrated circuit (ASIC), digital signal processor (DSP), digital signal processing device (DSPD), programmable logic device (PLD), field-programmable gate array (FPGA), controller, micro control unit, microprocessor or other electronic elements for executing the above method.

In an example, a non-transitory computer-readable storage medium including instructions is further provided, such as a memory 604 including the instructions. The above instructions may be executed by a processor 620 of an apparatus 600 so as to complete the above method. For example, the non-transitory computer-readable storage medium may be an ROM, a random access memory (RAM), a CD-ROM, a magnetic tape, a floppy disk, an optical data storage device and the like.

Those skilled in the art will easily figure out other implementation solutions of the examples of the disclosure after considering the specification and practicing the disclosure disclosed here. The disclosure intends to cover any variation, use or adaptive change of the examples of the disclosure, and these variations, uses or adaptive changes conform to a general principle of the examples of the disclosure and include common general knowledge or conventional technical means in the technical field not disclosed by the disclosure. The specification and the examples are merely regarded as examples, and the true scope and spirit of the examples of the disclosure are indicated by the following claims.

It is to be understood that the examples of the disclosure are not limited to an accurate structure described above and shown in the accompanying drawings, and various modifications and changes can be made without departing from its scope. The scope of the examples of the disclosure is limited merely by the appended claims.

### Industrial Applicability

For directional LBT, each sensing beam corresponds to an unlicensed channel occupy time, i.e., for one sending end device, each sensing beam has an own independent COT, such that when using at least one sensing beam to execute the directional LBT, the sending end device determines an occupancy time for a corresponding unlicensed channel according to the channel occupy time of each sensing beam, and a use duration of each unlicensed channel is controlled reasonably on the basis of the properties of the directional LBT of being capable of improving spatial selectivity and improving the channel detection efficiency.

1. A method for using an unlicensed channel, performed by a base station device or user equipment and comprising:
performing a listen before talk (LBT) detection on at least one sensing beam; wherein each sensing beam corresponds to a channel occupy time; and
using, after an idle unlicensed channel is detected on any sensing beam, the unlicensed channel according to the channel occupy time corresponding to the sensing beam.

2. The method according to claim 1, further comprising:
using, after the idle unlicensed channel is detected on any sensing beam, the sensing beam as a transmission beam to transmit data on the unlicensed channel.

3. The method according to claim 1, further comprising:
using, after the idle unlicensed channel is detected on any sensing beam, at least two transmission beams to transmit data on the unlicensed channel; wherein the at least two transmission beams are associated with the sensing beam.

4. The method according to claim 3, wherein the at least two transmission beams being associated with the sensing beam comprises:
a beam direction of each transmission beam in the at least two transmission beams and a beam direction of the sensing beam meeting a first set relationship.

5. The method according to claim 3, wherein the at least two transmission beams being associated with the sensing beam comprises:
a quasi co-location of each transmission beam in the at least two transmission beams and a quasi co-location of the sensing beam meeting a second set relationship.

6. The method according to claim 1, further comprising:
sharing the channel occupy time corresponding to the sensing beam by a plurality of transmission beams for transmitting data during switching of the transmission beams in a process of transmitting the data.

7. The method according to claim 6, wherein
sharing the channel occupy time corresponding to the sensing beam by the plurality of transmission beams for transmitting the data during switching of the transmission beams in the process of transmitting the data comprises:
consuming the channel occupy time corresponding to the sensing beam by data transmission duration on each transmission beam for transmitting the data.

8. (canceled)

9. A communication apparatus, comprising a processor and a memory;
the memory being configured to store a computer program; and
the processor being configured to execute the computer program so as to implement:
performing a listen before talk (LBT) detection on at least one sensing beam; wherein each sensing beam corresponds to a channel occupy time; and
using, after an idle unlicensed channel is detected on any sensing beam, the unlicensed channel according to the channel occupy time corresponding to the sensing beam.

10. A non-transitory computer-readable storage medium, storing instructions which cause, when called and executed on a computer, the computer to execute:
performing a listen before talk (LBT) detection on at least one sensing beam; wherein each sensing beam corresponds to a channel occupy time; and
using, after an idle unlicensed channel is detected on any sensing beam, the unlicensed channel according to the channel occupy time corresponding to the sensing beam.

11. The communication apparatus according to claim 9, wherein the processor is further configured to execute the computer program so as to implement:
using, after the idle unlicensed channel is detected on any sensing beam, the sensing beam as a transmission beam to transmit data on the unlicensed channel.

12. The communication apparatus according to claim 9, wherein the processor is further configured to execute the computer program so as to implement:
using, after the idle unlicensed channel is detected on any sensing beam, at least two transmission beams to transmit data on the unlicensed channel; wherein the at least two transmission beams are associated with the sensing beam.

13. The communication apparatus according to claim 12, wherein the at least two transmission beams being associated with the sensing beam comprises:
a beam direction of each transmission beam in the at least two transmission beams and a beam direction of the sensing beam meeting a first set relationship.

14. The communication apparatus according to claim 12, wherein the at least two transmission beams being associated with the sensing beam comprises:
a quasi co-location of each transmission beam in the at least two transmission beams and a quasi co-location of the sensing beam meeting a second set relationship.

15. The communication apparatus according to claim 9, wherein the processor is further configured to execute the computer program so as to implement:
sharing the channel occupy time corresponding to the sensing beam by a plurality of transmission beams for transmitting data during switching of the transmission beams in a process of transmitting the data.

16. The communication apparatus according to claim 15, wherein sharing the channel occupy time corresponding to the sensing beam by the plurality of transmission beams for transmitting the data during switching of the transmission beams in the process of transmitting the data comprises:
consuming the channel occupy time corresponding to the sensing beam by data transmission duration on each transmission beam for transmitting the data.

17. The non-transitory computer-readable storage medium according to claim 10, wherein the instructions cause, when called and executed on the computer, the computer to execute:
using, after the idle unlicensed channel is detected on any sensing beam, the sensing beam as a transmission beam to transmit data on the unlicensed channel.

18. The non-transitory computer-readable storage medium according to claim 10, wherein the instructions cause, when called and executed on the computer, the computer to execute:
using, after the idle unlicensed channel is detected on any sensing beam, at least two transmission beams to transmit data on the unlicensed channel; wherein the at least two transmission beams are associated with the sensing beam.

19. The non-transitory computer-readable storage medium according to claim 18, wherein the at least two transmission beams being associated with the sensing beam comprises:
a beam direction of each transmission beam in the at least two transmission beams and a beam direction of the sensing beam meeting a first set relationship.

20. The non-transitory computer-readable storage medium according to claim 18, wherein the at least two transmission beams being associated with the sensing beam comprises:
a quasi co-location of each transmission beam in the at least two transmission beams and a quasi co-location of the sensing beam meeting a second set relationship.

21. The non-transitory computer-readable storage medium according to claim 10, wherein the instructions cause, when called and executed on the computer, the computer to execute:
sharing the channel occupy time corresponding to the sensing beam by a plurality of transmission beams for transmitting data during switching of the transmission beams in a process of transmitting the data.
